(19) United States
(12) Patent Application Publication
(10) Pub. No.: US 2001/0043975 A1
(43) Pub. Date: Nov. 22, 2001

(54) METHODS AND APPARATUS FOR IMPARTING THE APPEARANCE AND TASTE OF HAVING BEEN COOKED ON AN OPEN GRILL TO UNGRILLED MEAT AND THE MEAT PREPARED BY SUCH PROCESS

(76) Inventors: LEWIS M. POPPLEWELL, MORGANVILLE, NJ (US); KURT J. AEBI, COCKEYSVILLE, MD (US)

Correspondence Address: OBLON SPIVAK MCCLELLAND MAIER & NEUSTADT, FOURTH FLOOR, 1755 JEFFERSON DAVIS HIGHWAY, ARLINGTON, VA, 22202

(21) Appl. No.: 09/480,795

(22) Filed: Jan. 11, 2000

Related U.S. Application Data
(60) Provisional application No. 60/115,381, filed on Jan. 11, 1999.

(51) Int. Cl. A23L 1/00

(52) U.S. Cl. 426/383; 426/523; 426/641; 99/339

(57) ABSTRACT

Creating a depression in at least one surface of uncooked meat and dispensing a colorant and/or flavorant into said depression affords uncooked meat which will have the look and/or taste of grilled meat even after being cooked by some other method. Such a method may be carried out by an apparatus which comprises: (1) means for forming a depression in uncooked meat; and (2) means for dispensing a colorant and/or flavorant into said depression.

### BACKGROUND OF THE INVENTION

1. Field of the Invention

The present invention relates to a method for imparting the appearance and/or taste of having been grilled to ungrilled meat. The present invention also relates to an apparatus for carrying out such a method. The present invention further relates to uncooked and cooked meat prepared by such a process.

2. Description of the Background

Open-grilled meat is very popular. In addition to imparting a particular taste to the meat, cooking meat on an open grill also results in the meat being marked with a distinctive pattern of grill marks. Both the imparted taste and grill marks are desired characteristics.

However, it is not always possible to cook meats on an open grill. For example, most home kitchens are not equipped with indoor open grills, and many people do not like to use outdoor open grills during the cold winter months. Likewise many restaurants, including many fast-food restaurants which specialize in hamburgers and chicken sandwiches, cook their meat on griddles rather than open grills. Even some fast food restaurants which do cook the meat on an open grill do so only on one side of the meat, so that only one side of the meat has grill marks.

Thus, it would desirable to be able to impart the look and taste of having been cooked on an open grill to meat that has not been cooked on an open grill.

Current approaches to flavoring/coloring/texturizing formed meat products typically involve either blending flavors with the meat prior to forming, topically applying flavors prior to freezing or cooking, or applying flavors after cooking. Each of these approaches has drawbacks:

Mixing flavor materials with the meat may negatively effect product shelf-life in either the refrigerated or frozen state. This is especially true if salts and acids are included in the flavor.

Topical application of flavors prior to freezing is difficult to achieve without substantial wastage, may contaminate the equipment used for freezing, and places the flavor in a position to negatively effect product shelf-life. Further, the flavor material may be removed via abrasion in the frozen state, or during unavoidable freeze-thaw cycles

Topical application of the flavor prior to cooking is likely to result in substantial wastage, and in inconsistency if preparation is done in an institutional feeding setting.

Applying flavor after cooling can result in wastage, inconsistency, and may not be able to produce the “cooked in” flavor desired.

Thus, there remains a need for a method to economically apply flavor/color/texturizing agents to formed meat products prior to cooking in a way that ensures consistency, prevents shelf-life problems, avoids flavor loss during storage, and that can deliver a variety of consistent flavor profiles. In particular, there remains a need for a method for imparting the look and/or taste of having been cooked on an open grill to meat which has not been cooked on an open grill. There also remains a need for an apparatus for carrying out such a method. There also remains a need for uncooked meat which will have the look and/or taste of having been cooked on an open grill even after cooking by some other method. There also remains a need for cooked meat which has the look and/or taste of having been cooked on an open grill even though it has not been cooked on an open grill.

### SUMMARY OF THE INVENTION

Accordingly, it is one object of the present invention to provide a novel method for imparting the look and/or appearance of having been cooked on an open grill to meat which has not been cooked on an open grill.

It is another object of the present invention to provide novel apparatus for carrying out such a method.

It is another object of the present invention to provide novel uncooked meat which will have the look and/or taste of having been cooked on an open grill even after having been cooked by some other method.

It is another object of the present to provide a novel method for preparing such uncooked meat.

It is another object of the present invention to provide novel cooked meat which will have the look and/or taste of having been cooked on an open grill even though it has been cooked by some other method.

It is another object of the present to provide a novel method for preparing such cooked meat.

These and other objects, which will become apparent during the following detailed description, have been achieved by the inventors' discovery that:

(A) creating a depression in at least one surface of uncooked meat; and

(B) dispensing a colorant and/or flavorant into said depression affords uncooked meat which will have the look and/or taste of grilled meat even after being cooked by some other method.

The inventors have also discovered that such a method may be carried out by an apparatus which comprises:

(1) means for forming a depression in uncooked meat; and

(2) means for dispensing a colorant and/or flavorant into said depression.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a planar view of one embodiment of the present meat, in which the grill marks occur in a pattern of parallel lines;

FIG. 2 is a planar view of one embodiment of the present meat, in which the grill marks occur in a pattern of crossed sets of parallel lines; and

FIG. 3 shows the manufacturing of ground beef patties in which a flavorant is dispensed into depressions in a pattern of parallel lines by means of an apparatus according tot the present invention.

### DETAILED DESCRIPTION OF THE PREFERRED EMBODIMENTS

Thus, in a first embodiment, the present invention provides a novel method imparting the look and/or taste of having been cooked on an open grill to meat which either will not be or has not been cooked on an open grill. In the context of the present invention, the term having the look of having been cooked on an open grill means that at least one side of the meat has a regular pattern of marks which are similar to those imparted to meat when it is cooked on an open grill. The term having the taste of having been cooked on an open grill means having those flavor notes imparted to a food product which has been exposed to high temperature such as from an open flame or burning wood or charcoal. The term having been cooked on an open grill means that the meat has been cooked while suspended or traveling over a heat source, such as a flame or radiant heat source, by resting on a supporting member which has openings which are smaller than the meat.

Thus, the present invention provides a method for preparing uncooked meat, which will have the look and/or taste of having been cooked on an open grill, even when cooked by some other method, which process comprises:

(A) forming a depression on at least one surface of uncooked meat or meat-like product; and

(B) dispensing an ingredient selected from the group consisting of colorants and flavorants into said depression.

Suitable meats include any uncooked meat, e.g., ground beef patties, ground pork patties, ground chicken patties, ground turkey patties, ground veal patties, ground lamb patties, beef filets, pork filets, chicken filets, turkey filets, veal filets, fish (e.g., salmon, trout, bass, cod, flounder, sole, tuna, swordfish, etc.) filets, beef steaks, pork chops, lamb chops, bone-in chicken pieces, and fish (e.g., salmon, tuna, swordfish, etc.) steaks. It is also to be understood that the present method may be beneficially applied to other foods which are often grilled, such as meat-like products, e.g., vegetable or soy burgers.

Preferably, the meat is boneless, such a ground meat patty or a meat or fish filet. In a particularly preferred embodiment, the meat is a ground beef patty or a chicken filet.

Preferably, at the time the depression is formed, the meat is fresh (previously unfrozen) or previously frozen meat which has been thawed sufficiently to allow the easy formation of the depression.

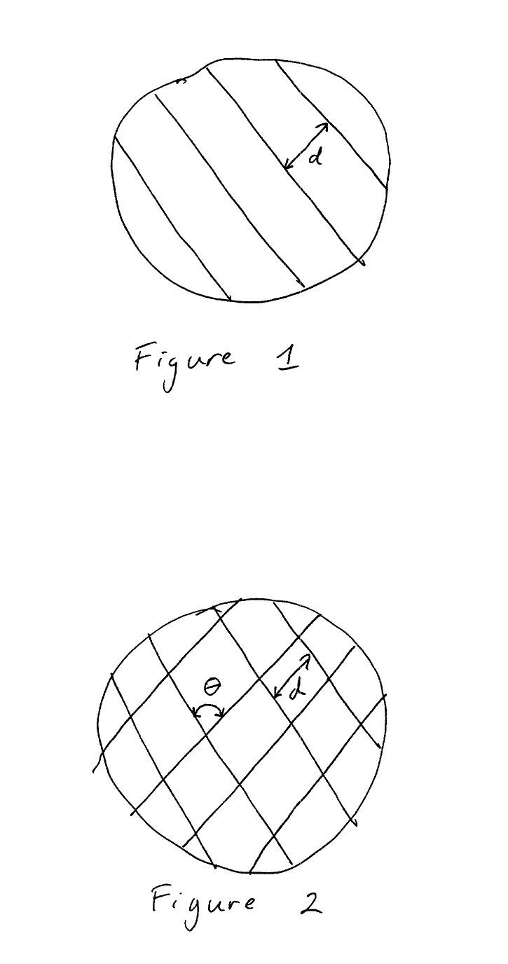

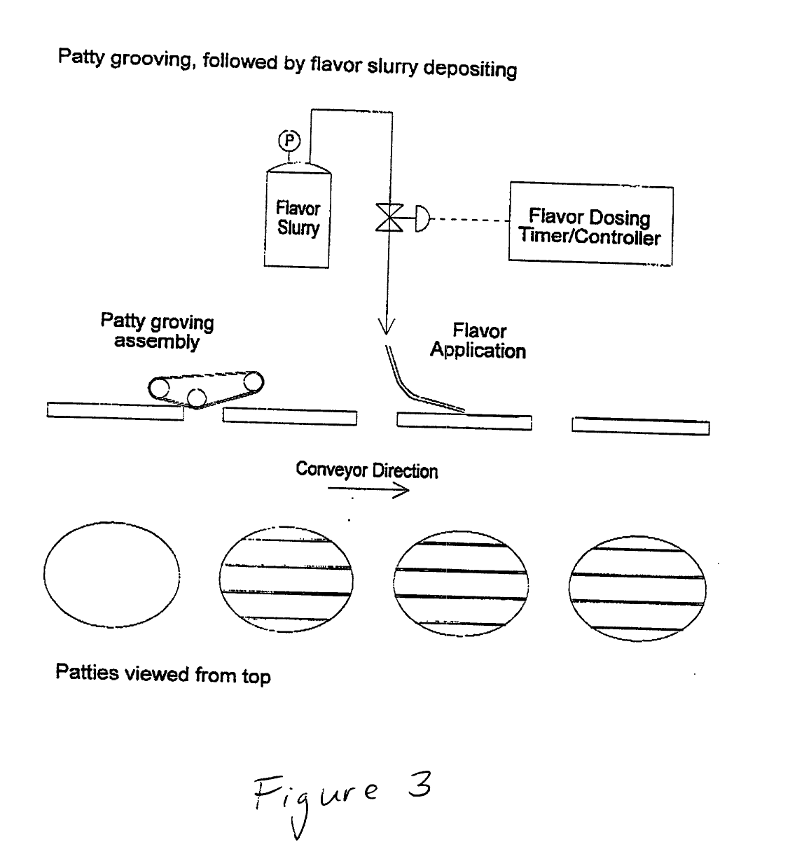

The depression made in the uncooked meat is suitably 1 to 10 mm deep, preferably 3 to 8 mm deep. In a particularly preferred embodiment, a pattern of depressions is formed on at least one surface of the meat. A typical pattern of parallel lines is shown in FIG. 1. In this embodiment, the parallel depressions are suitably spaced at a distance, d, of 5 to 25 mm, preferably 8 to 20 mm. Thus, for a typical ground meat patty, the pattern will consist of 1 to 10 parallel lines, preferably 3 to 6 parallel lines. A second embodiment, in which the pattern of depressions is that of two sets of parallel lines is shown in FIG. 2. In this embodiment, both sets of parallel depressions are each suitably spaced at a distance, d, of 5 to 25 mm, preferably 8 to 20 mm, and the two parallel sets of depressions intersect at an angle, θ, of 30° to 120°, preferably 80° to 100°.

The depression may be made by a suitable device. For example, the depression may be made by hand using a hand-held device which contains a means for gripping, such as a handle, and means for forming the depression, such as a blade, brand, or tine, which upon striking or pressing against the uncooked meat cuts or otherwise leaves a depression. The hand-held device may contain a single blade, brand, or tine, which can be used repeatedly to form a pattern or, more preferably, have multiple blades, brands, or tines such that the desired pattern is formed with a single strike or press. The depression may also be made by placing the meat in a mold and applying pressure or by simply forming the meat in a mold, in which the depression is formed by a raised portion on the inside surface of the mold. This last method may be particularly preferred when forming the depression on the surface of ground meat patties, as the depression can be formed at the same time as the patty itself.

Alternatively, the depression may be made by an automated machine. Suitable automated machines comprise a motor which supplies the energy for forming the depression. Again, the depression can be formed by either striking or pressing the meat with a blade, brand, or tine or by molding. With whole meats, such as boneless chicken or bone-in chicken pieces, fish filets and steaks, the grooves may be stamped or cut into the surface by passing the meat portion through a series of compressive/cutting disks or knives, with the flavorant deposited into the grooves. If an overall dish type depression in the meat is desired, a depositing device could be used to fill the depression with a flavor. Such automated machines may further comprise conveying means, such a conveyor belt or screw conveyor for carrying portions of the meat to that part of the machine in which the depression is formed.

After the depression has been formed, the colorant and/or flavorant is dispensed into the depression. When one wishes to impart only the look of having been cooked on an open grill, then only a colorant need be dispensed into the depression. When one wishes to impart only the taste of having been cooked on an open grill, then only a flavorant need be dispensed into the depression. When one wishes to impart both the look and taste of having been cooked on an open grill, then a flavorant and colorant should be dispensed into the depression. Of course, it should be understood that some ingredients will serve a dual role acting as both a colorant and a flavorant. Dispensing such an ingredient into the depression will serve to impart both the look and taste of having been cooked on an open grill.

Suitable colorants include natural and artificial colors.

Suitable flavorants include natural and artificial flavors, salts, acids, liquid and dried flavors hydrolyzed vegetable proteins, autolyzed yeast, spices, cheese emulsions and powders, processed cheese, smoke/grill flavors, vegetable powders, caramel colors, browning agents, texturizing agents (such as papain, bromelain, or other meat tenderizers), carriers such as maltodextrins and starches, fats and oils, reactants for reaction-based flavors such as reactive sugars and reactive amines, sugars such as xylose, dextrose, and lactose.

The invention is designed to preferentially use liquid or slurry type flavors. These may be either aqueous or lipid based depending on the flavor/color/texture desired, the specific process employed after flavor application, and the distribution conditions.

The colorant and/or favorant may be dispensed into the depression by any suitable means, such as by a nozzle, brush, dropper, etc. Dry seasonings or flavors may be applied into the grooves or depressions through pneumatic or gravimetric conveyance devices.

In a particularly preferred embodiment, a pattern of depressions is made on a surface of a ground meat patty using the apparatus shown in FIG. 3, in which the ground meat patties pass on a conveyor under a patty grooving assembly which has a plurality (preferably 3 to 6) raised ribs which imprint a pattern of grooves (depressions) on the top surface of the patties. The patty is then conveyed under a flavorant dispenser which has a plurality of outlets (preferably 3 to 6) which correspond spatially to the grooves (depressions) on the surface of the patty and dispense the flavorant (colorant) into the depressions.

After the dispensing of the colorant and/or flavorant into the depression, the meat may be cooked, packaged for sale unfrozen or frozen. Eventually, the surface of the meat will be cooked in some way other than on an open grill. Such types of cooking include, roasting, baking, pan frying, frying on a griddle, steaming, etc. However, the present method may also be applied to meats which will be cooked on an open grill only on one side, by forming the depression and dispensing the colorant and/or flavorant on the side which will not be on the open grill. In this way, both sides of the meat will appear and taste like they have been cooked on the open grill, when in reality only was side was so-cooked.

Thus, the present invention essentially involves creating a depression in an article of fresh formed meat, and then filling that depression with either a liquid, dry, or slurry flavor/color/texturizing agent system designed to impart a specific flavor/color/texture/aroma to the cooked product. The system is envisioned as most useful for flavoring hamburgers, and providing grooved lines simulating grill marks.

By forming depressions (e.g. grooves or channels) in the formed meat product and then filling the depressions with a flavor, a number of problems are overcome. First, there is little wastage due to the defined application of the flavoring into the depressions. Second, the flavoring is protected by being either wholly or partially below the surface of the meat both during freezing, in the frozen state, and during distribution. Third, the defined application of flavor in the depressions minimizes the possibility of flavor components negatively effecting product shelf-life.

Further, the specific type and pattern of depressions may be used to influence the final appearance of the formed meat product. For example, if linear grooves are used with the correct flavor/color combination, then a grilled appearance will result even if the burger is cooked in some other way.

The benefits of the invention include:

Economical application of flavor/color/texturizing agents to formed meat products.

Improved shelf-life over topical application.

Less contamination of downstream processing equipment.

Less chance of flavor/color/texturizing agent loss during distribution.

The opportunity to create a defined pattern or appearance on the burger surface.

The meat prepared is further characterized by the fact that the flavorant and/or colorant is substantially present in the depressions and substantially absent from the other portions of the surface of the meat. Preferably, at least 75 wt. %, preferably at least 90 wt. %, of the applied colorant and/or flavorant is present in the depressions on the surface of the meat.

Other features of the invention will become apparent in the course of the following descriptions of exemplary embodiments which are given for illustration of the invention and are not intended to be limiting thereof.

### EXAMPLES

In the following examples, and throughout this specification, all parts and percentages are by weight, and all temperatures are in degrees Celsius, unless expressly stated to be otherwise. Where the solids content of a dispersion or solution is reported, it expresses the weight of solids based on the total weight of the dispersion or solution, respectively.

### Example 1

Frozen, pre-formed hamburger patties of approximately 130 grams were thawed to approximately refrigerator temperature. Five grooves extending the length of the patty were pressed into the patties. The grooves were approximately 6 mm in width. A fat slurry flavoring/coloring blend was then deposited along the grooves, using an injection nozzle. This blend was approximately 50% fat, and contained both liquid and solid flavorings and colors. Approximately 4 grams was used per patty. The patties were then re-frozen to approximately 0°-10° F. Frozen patties were cooked using a grill with both top and bottom heating. The grooved, filled side was placed up. Once finished cooking, the patties showed obvious “grill” marks where the grooves had been, and had a distinct flavor as delivered by the added flavor components.

Obviously, numerous modifications and variations of the present invention are possible in light of the above teachings. It is therefore to be understood that, within the scope of the appended claims, the invention may be practiced otherwise than as specifically described herein.

What is claimed as new and desired to be secured by letters patent of the united states is:

1. A method for treating meat or meat-like product, comprising:
(A) creating a depression in at least one surface of uncooked meat or meat-like product; and
(B) dispensing an ingredient selected from the group consisting of colorants and flavorants into said depression.

2. The method of claim 1, further comprising:
(C) cooking said meat or meat-like product on said at least one surface by a means other than on an open grill.

3. The method of claim 1, further comprising:
(C′) freezing said meat or meat-like product.

4. The method of claim 1, wherein said colarant is a natural or artificial color.

5. The method of claim 1, wherein said flavorant is selected from the group consisting of natural and artificial flavors, salts, acids, liquid and dried flavors hydrolyzed vegetable proteins, autolyzed yeast, spices, cheese emulsions and powders, processed cheese, smoke/grill flavors, vegetable powders, caramel colors, browning agents, texturizing agents, carriers such as maltodextrins and starches, fats and oils, reactants for reaction-based flavors such as reactive sugars and reactive amines, sugars such as xylose, dextrose, and lactose.

6. The method of claim 5, wherein said texturizing agent is selected from the group consisting of papain, bromelain, and other meat tenderizers.

7. The method of claim 5, wherein said meat or meat-like product is selected from the group consisting of ground beef patties, ground pork patties, ground chicken patties, ground turkey patties, ground veal patties, ground lamb patties, beef filets, pork filets, chicken filets, turkey filets, veal filets, fish filets, beef steaks, pork chops, lamb chops, bone-in chicken pieces, fish steaks, and soy burgers.

8. A treated meat or meat-like product prepared by a process comprising:
(A) creating a depression in at least one surface of uncooked meat or meat-like product; and
(B) dispensing a colorant and/or flavorant into said depression.

9. The treated meat or meat-like product of claim 8, wherein said process further comprises:
(C) cooking said meat or meat-like product on said at least one surface by a means other than on an open grill.

10. The treated meat or meat-like product of claim 8, wherein said process further comprises:
(C′) freezing said meat or meat-like product.

11. The treated meat or meat-like product of claim 8, wherein said colarant is a natural or artificial color.

12. The treated meat or meat-like product of claim 8, wherein said flavorant is selected from the group consisting of natural and artificial flavors, salts, acids, liquid and dried flavors hydrolyzed vegetable proteins, autolyzed yeast, spices, cheese emulsions and powders, processed cheese, smoke/grill flavors, vegetable powders, caramel colors, browning agents, texturizing agents, carriers such as maltodextrins and starches, fats and oils, reactants for reaction-based flavors such as reactive sugars and reactive amines, sugars such as xylose, dextrose, and lactose.

13. The treated meat or meat-like product of claim 12, wherein said texturizing agent is selected from the group consisting of papain, bromelain, and other meat tenderizers.

14. The treated meat or meat-like product of claim 8, wherein said meat or meat-like product is selected from the group consisting of ground beef patties, ground pork patties, ground chicken patties, ground turkey patties, ground veal patties, ground lamb patties, beef filets, pork filets, chicken filets, turkey filets, veal filets, fish filets, beef steaks, pork chops, lamb chops, bone-in chicken pieces, fish steaks, and soy burgers.

15. A treated portion of meat or meat-like product, comprising:
(1) at least one depression on at least one surface of said meat or meat-like product; and
(2) an ingredient selected from the group consisting of flavorants and colorants within said depression.

16. The treated meat or meat-like product of claim 15, wherein said colarant is a natural or artificial color.

17. The treated meat or meat-like product of claim 15, wherein said flavorant is selected from the group consisting of natural and artificial flavors, salts, acids, liquid and dried flavors hydrolyzed vegetable proteins, autolyzed yeast, spices, cheese emulsions and powders, processed cheese, smoke/grill flavors, vegetable powders, caramel colors, browning agents, texturizing agents, carriers such as maltodextrins and starches, fats and oils, reactants for reaction-based flavors such as reactive sugars and reactive amines, sugars such as xylose, dextrose, and lactose.

18. The treated meat or meat-like product of claim 17, wherein said texturizing agent is selected from the group consisting of papain, bromelain, and other meat tenderizers.

19. The treated meat or meat-like product of claim 15, wherein said meat or meat-like product is selected from the group consisting of ground beef patties, ground pork patties, ground chicken patties, ground turkey patties, ground veal patties, ground lamb patties, beef filets, pork filets, chicken filets, turkey filets, veal filets, fish filets, beef steaks, pork chops, lamb chops, bone-in chicken pieces, fish steaks, and soy burgers.

20. An apparatus for treating meat or meat-like product, comprising:
(1) means for forming a depression in uncooked meat or meat-like product; and
(2) means for dispensing a colorant and/or flavorant into said depression.
